(19) United States
(12) Patent Application Publication
(10) Pub. No.: US 2019/0363896 A1
(43) Pub. Date: Nov. 28, 2019

(54) BLOCKCHAIN BASED DECENTRALIZED AND DISTRIBUTED CERTIFICATE AUTHORITY

(71) Applicant: Keir Finlow-Bates, Kangasala (FI)

(72) Inventor: Keir Finlow-Bates, Kangasala (FI)

(21) Appl. No.: 15/990,604

(22) Filed: May 26, 2018

(51) Int. Cl. H04L 9/32

(52) U.S. Cl. CPC H04L 9/3268; H04L 9/3265; G06Q 20/38215; H04L 2209/38; H04L 9/3247

(57) ABSTRACT

A system and method for creating, sharing and revoking digital certificates in a decentralized and distributed manner, without a need for a central Certificate Authority is presented. A blockchain is initiated, with a root certificate published in one of an initial blocks of the blockchain. The root certificate may subsequently issue further certificates to other participants on the blockchain, or participants may submit certificates to the blockchain for signing by the root certificate. Notification of a revocation of certificates may be performed through the blockchain. The blockchain provides a final single view of a true state of the digital certificates in the system and their respective authority and validity. The issuing of further certificates, signing of certificates and revocation of certificates may be associated with a transfer of digital credits of commercial value.

### TECHNICAL FIELD

This disclosure relates to computer systems and methods concerned with a creation, distribution and revocation of digital certificates, and more specifically to a distributed and decentralized method and system for processing digital certificates using a blockchain.

### BACKGROUND

Distributed ledgers or blockchains provided in, for example, a peer-to-peer network, such as the distributed ledger used in the Bitcoin cryptocurrency system, allow participants on the peer-to-peer network to participate in a sharing of data in a distributed manner without a need for a central authority.

A public key infrastructure (PKI) may rely on digital certificates in order to identify parties operating in a system, and to enable encrypted secure communication between parties. For example, digital certificates are used to identify web sites, and to enable clients to connect and download web pages over a secure connection, using secure sockets layer (SSL) or transport layer security (TLS) cryptographic protocols. Similarly, Internet of Things (IoT) devices may communicate securely using digital certificates using datagram transport layer security (DTLS) cryptographic protocols.

In order to trust the digital certificates, a root certificate may sign other certificates, providing other certificates with validity. The PKI thus relies on a trust in the root certificate.

In a centralized system an issue of establishing the trust is overcome by faith in a reliability of a central authority, which owns the root certificate. The policies and processes a provider uses to decide which certificate authorities their software should trust are called root programs.

A centralized system operator may also be responsible for a distribution of valid certificates, and for maintaining a public register of certificates issued and revoked.

However, centralized systems and centralized root programs have a number of problems. The central authority may have the ability to arbitrarily issue and revoke certificates. Furthermore, central authorities usually charge for their services, resulting in higher costs for users of the system.

It is therefore the intention of the present disclosure to address the problem of enabling a public key infrastructure and certificate distribution in a decentralized fashion without recourse to a central authority.

### SUMMARY

In accordance with the present disclosure, example embodiments are described for distributing, signing and revoking digital certificates on a blockchain.

An example embodiment may include a method comprising one or more of: initiating a blockchain, publishing a root certificate on the blockchain, retrieving a message comprising a signing request for a digital certificate, generating a signature in response to the message using a key associated with the root certificate, and publishing the signature on the blockchain.

In the example embodiment, the root certificate may be published in an initial block of the blockchain. The initial block may comprise a first block of the blockchain, or a one of a subsequent blocks of the blockchain.

In the example embodiment, participants on the blockchain may reject a validity of the digital certificate if the blockchain does not comprise the signature.

In the example embodiment, participants on the blockchain may further reject the validity of the digital certificate if a revocation message for the digital certificate is published on the blockchain. In a further embodiment, the revocation message may be signed by an authorizing digital certificate. The authorizing digital certificate may comprise the root certificate, or a further certificate provided with authority through a chain of signatures commencing with a root certificate signature. Certificates in the chain may provide the further certificate with the authority to sign other certificates.

In the example embodiment, the message comprising the signing request may further comprise an offering of a digital credits of commercial value. In the example embodiment, publishing the signature in response to the signing request may be associated with claiming the digital credits of commercial value.

In the example embodiment, a smart contract may run on the blockchain, said smart contract comprising one or more of the signature, the root certificate, the message, the digital certificate, the digital credits of commercial value. The smart contract may verify the signature, and may reallocate the digital credits of commercial value.

An other example embodiment may include an apparatus that comprises one or more of a processor configured to initiate a blockchain, and a transceiver configured to publish a root certificate on the blockchain. The transceiver may be further configured to retrieve a message comprising a signing request for a digital certificate. The processor may be further configured to generate a signature in response to the message, using a key associated with the root certificate. The transceiver may be yet further configured to publish the signature on the blockchain.

In the other example embodiment, the transceiver may be configured to publish the root certificate in an initial block of the blockchain. The initial block may comprise a first block of the blockchain, or a one of a subsequent blocks of the blockchain.

In the other example embodiment, the processor may be configured to reject a validity of the digital certificate if the blockchain does not comprise the signature.

In the other example embodiment, participants on the blockchain, such as but not limited to the processor and the transceiver, may be configured to further reject the validity of the digital certificate if a revocation message for the digital certificate is published on the blockchain. In a further other embodiment, the revocation message may be signed by an authorizing digital certificate. The authorizing digital certificate may comprise the root certificate, or a further certificate provided with authority through a chain of signatures commencing with a root certificate signature. Certificates in the chain may provide the further certificate with the authority to sign other certificates.

In the other example embodiment, the message comprising the signing request may further comprise an offering of a digital credits of commercial value. In the other example embodiment, the transceiver may be configured to publish the signature in response to the signing request, and the processor may be configured to claim the digital credits of commercial value.

In the other example embodiment, a smart contract may run on the blockchain, said smart contract comprising one or more of: the signature, the root certificate, the message, the digital certificate, the digital credits of commercial value. The smart contract may verify the signature, and may reallocate the digital credits of commercial value.

A yet another example embodiment may include a non-transitory computer readable medium configured to store instructions that when executed cause a processor and a transceiver to perform one or more of: initiating a blockchain, publishing a root certificate on the blockchain, retrieving a message comprising a signing request for a digital certificate, generating a signature of the digital certificate using a key associated with the root certificate, and publishing the signature on the blockchain.

In the yet another example embodiment, the processor may be configured by instructions to publish the root certificate in an initial block of the blockchain. The initial block may comprise a first block of the blockchain, or a one of a subsequent blocks of the blockchain.

In the yet another example embodiment, the processor may be configured by instructions to reject a validity of the digital certificate if the blockchain does not comprise the signature.

In the yet another example embodiment, participants on the blockchain, such as but not limited to the processor, may be configured through instructions to further reject the validity of the digital certificate if a revocation message for the digital certificate is published on the blockchain. In a further yet another embodiment, the revocation message may be signed by an authorizing digital certificate. The authorizing digital certificate may comprise the root certificate, or a further certificate provided with authority through a chain of signatures commencing with a root certificate signature. Certificates in the chain may provide the further certificate with the authority to sign other certificates.

In the yet another example embodiment, the message comprising the signing request may further comprise an offering of a digital credits of commercial value. In the yet another example embodiment, the processor may be configured by instructions to publish the signature in response to the signing request, and the processor may be configured by instructions to claim the digital credits of commercial value.

Those skilled in the art will further appreciate the advantages and superior features found in this disclosure together with other important aspects thereof on reading the detailed description that follows in conjunction with the drawings.

### BRIEF DESCRIPTION OF THE DRAWINGS

The components in the figures are not necessarily to scale, emphasis instead being placed upon illustrating the principles of the present disclosure. In the figures, like reference numerals designate corresponding parts throughout the different views.

FIG. 1 illustrates a device configured to support one or more of the example embodiments.

FIG. 2 illustrates initiating a blockchain and subsequently publishing a certificate on an initial block.

FIG. 3 illustrates a process comprising a publishing of a signing request for a digital certificate on a blockchain, and a process comprising signing the digital certificate and publishing a signature on the blockchain.

FIG. 4 is a flow diagram illustrating an acceptance or rejection of a digital certificate on the basis of a presence or absence of an authorization for the digital certificate on the blockchain.

FIG. 5 is an exemplary embodiment of a message comprising a signing request for a digital certificate and an offering of credits of commercial value.

FIG. 6 is an illustration of a chain of digital certificates and authorization signatures on a blockchain.

FIG. 7 is a block diagram illustrating a structure of a possible embodiment of a revocation message.

FIG. 8 is a programmatic diagram illustrating a structure of a smart contract providing functions and methods related to digital certificates and associated token payments.

FIG. 9 is an illustration of a peer-to-peer network with a plurality of devices connected to the peer-to-peer network, in accordance with an embodiment of the present invention.

### DETAILED DESCRIPTION

Various aspects of this disclosure are now described with reference to the drawings. In a description that follows, specific details are provided to promote a thorough understanding of one or more aspects of the disclosure.

The present disclosure is directed to a method, apparatus, and system for providing a decentralized and distributed certificate authority using blockchain technology.

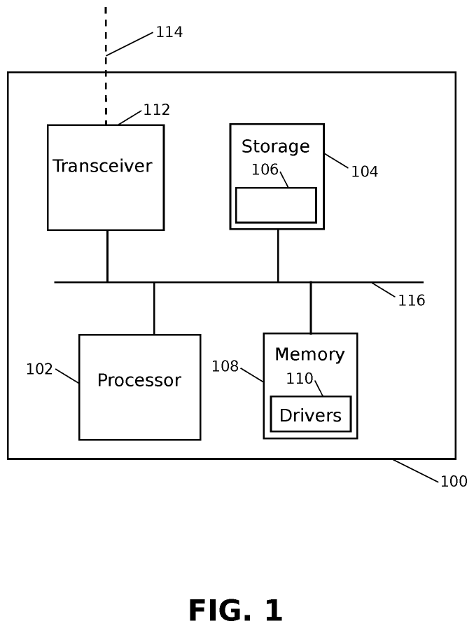

In FIG. 1, an embodiment of a device 100 participating on a blockchain is presented.

In the embodiment, the device 100 may comprise a processor 102, comprising one or more central processing units (CPUs), capable of executing instructions stored in a memory 108, and controlling other peripheral components through drivers 110 stored within the memory.

Further storage 104 may be present, which may comprise a cryptographically secure partition 106 or other component where cryptographic keys may be securely stored. Instructions may be retrieved from the storage 104 and transferred to the memory 108 as required.

The device 100 may comprise a transceiver 112, which may connect the device 100 to a network. The transceiver 112 may consist of a direct wired connection to a packet switched network through a cable 114. In other embodiments a connection to the network may be through wireless components comprising one or more wireless modules implemented in firmware or hardware, for example, a wireless local area network (WLAN) unit such as a WiFi adapter utilizing an 802.11 protocol, a wireless wide area network (WWAN) unit such as Global System for Mobile communications (GSM), Long Term Evolution (LTE), or other cellular wireless data communication system.

Components comprising the device 100 may communicate through a bus 116, which may be implemented as a peripheral component interconnect express (PCIe) bus, a universal serial bus (USB), a universal asynchronous receiver/transmitter (UART) serial bus, a suitable advanced micro-controller bus architecture (AMBA) interface, a serial digital input output (SDIO) bus, or other equivalent interface.

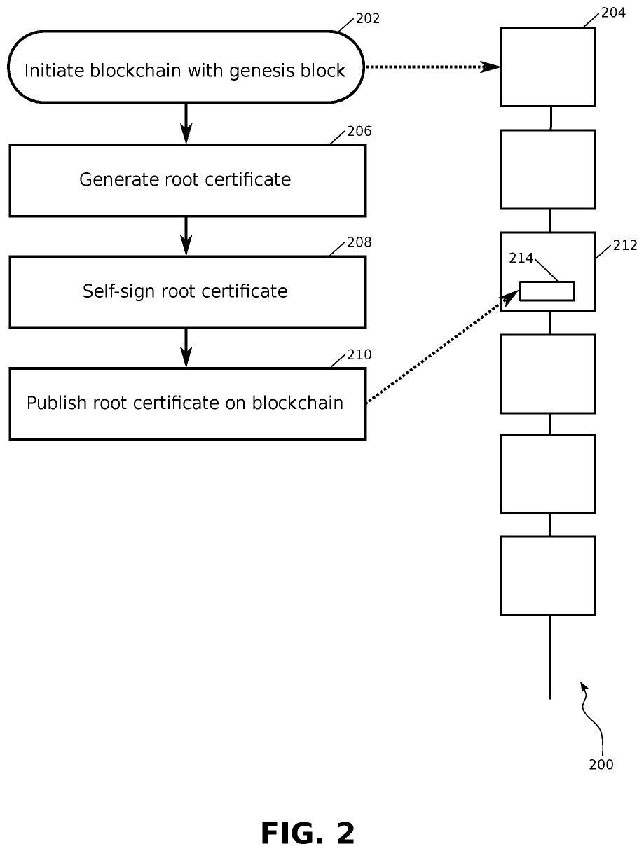

FIG. 2 presents a method for a device to instantiate a blockchain 200 and publish a self-signed root certificate 214.

Operations may commence with an initiation of a blockchain through a publishing of a genesis block 204 on a peer-to-peer network, as shown in step 202. Software, comprising computer instructions, may construct the genesis block 204 in accordance with a blockchain protocol agreed upon by participants on the peer-to-peer network.

Operations may proceed with a generation of a root certificate, as shown in step 206. The root certificate may be generated in compliance with an X.509 standard, a card verifiable certificate (CVC) standard, an OpenPGP format, or some other certificate standard or format.

Operations may then proceed with a self-signing of the root certificate, as shown in step 208.

Operations may then conclude by publishing the self-signed root certificate 214 on the blockchain 200, for inclusion in a block 212 of the blockchain 200, as shown in step 210.

In some embodiments the block 212 and the genesis block 204 may be a same entity.

In other embodiments, a blockchain protocol may stipulate that the block 212 be an initial block. An initial block may be defined as a block that has a block height less than a predetermined number. In the present example, the block height of a current block may be defined as a count of a number of blocks from the genesis block 204 to the current block.

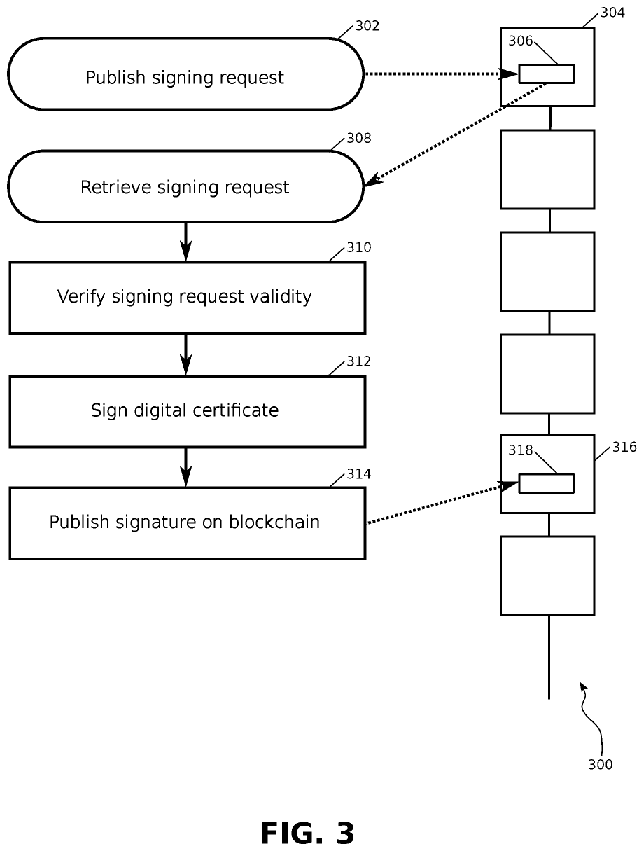

In FIG. 3, a signing request process comprising a publishing of a signing request 306 for a digital certificate on a blockchain 300, and a digital signing process comprising signing the digital certificate and publishing a signature 318 on the blockchain 300, are presented.

Operations for requesting a signature for a digital certificate may commence with step 302, in which the signing request 306 for a digital certificate may be generated and published in a block 304 on the blockchain 300. The signing request 306 may comprise one or more of: an unsigned digital certificate, a self-signed digital certificate, a previously signed digital certificate, a specification indicating from which signee a digital signature is requested, an offering of digital credits of commercial value or other form of token or cryptocurrency, a time limit for signing.

Operations for signing a digital certificate may commence with step 308. The signing request 306 may be detected on the blockchain, and may be retrieved, as shown in step 308.

Operations may proceed with an examination and parsing of the signing request 306 to determine a validity of the signing request 306, as shown in step 310. Determining the validity may comprise one or more of: confirming the signing request conforms with a protocol of the blockchain 300, confirming the signing request 306 comprises a valid digital certificate, confirming the signing request 306 was submitted at a time specified in the signing request 306, confirming a current time lies within a time limit specified in the signing request 306, determining that the signing request 306 is for a valid signee.

Operations may then proceed with a signing of the digital certificate, as shown in step 312. The digital signature may be signed with a root certificate, or an intermediate certificate, previously published on the blockchain 300.

Operations may then conclude with a publishing of the signature 318 on the blockchain, for inclusion in a block 316, as shown in step 314. The signature 318 may comprise one or more of: a header indicating the signature comprises a signed digital certificate, the valid digital certificate contained within the signing request 306 signed by the root certificate or the intermediate certificate, a time stamp, a claim to the offering of digital credits of commercial value or other form of token or cryptocurrency.

In an embodiment of this disclosure, the block 316 may necessarily be a subsequent block to the block 304.

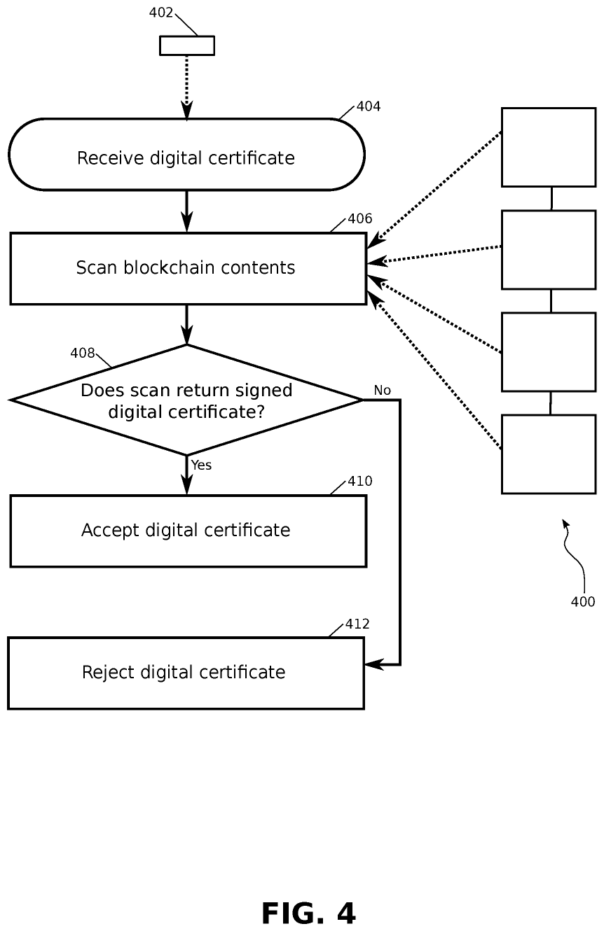

In FIG. 4, a flow diagram illustrating a method for an acceptance or rejection of a digital certificate 402 on the basis of an presence or absence of an authorization for the digital certificate 402 on the blockchain 400 is presented.

In an embodiment, operations may commence through a receiving of the digital certificate 402, as shown in step 404.

The blockchain 400 may then be scanned for confirmation that the digital certificate 402 has been published on the blockchain, and that a valid signature has been provided, as shown in step 406. In other embodiments, one or more or all certificates and signatures may be extracted from the blockchain 400 at a prior time, and stored in a database for faster searching and scanning.

In step 408 the method may proceed depending on an outcome of a scan for a signed copy of the digital certificate, signature, or other authorization or confirmation of the validity of the digital certificate. If the scan determines that the digital certificate is valid and/or correctly signed, operations may proceed to step 410 and the digital certificate may be accepted.

If the scan determines that the digital certificate is invalid and/or incorrectly signed or not signed at all, operations may proceed to step 412, and the digital certificate may be rejected.

In some embodiments, an accepted digital certificate may then be used for one or more of: further secure communication, as evidence of identity, or for other purposes to which digital certificates may be applied.

In other embodiments, a rejected digital certificate may then be discarded, blacklisted, or barred from being used for one or more of: further secure communication, as evidence of identity, or for other purposes to which digital certificates may be applied.

Those skilled in the art will appreciate that different digital certificates may comprise different levels of authority and associated uses, and that the disclosure above for FIG. 4 may be extended to selectively determine which level of authority or associated use applies in each specific case.

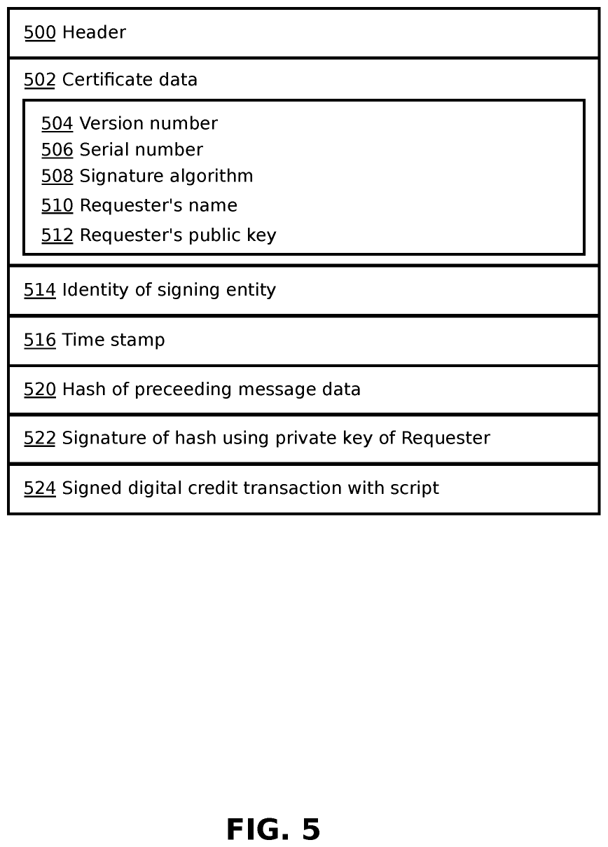

In FIG. 5 an exemplary embodiment of a message comprising a signing request for a digital certificate and an offering of credits of commercial value, that may be published on a blockchain, is presented.

The message may comprise a header 500, which in some embodiments may comprise: an identifier indicating that the message comprises a signing request, a size of the message, a protocol for the message, a structure of data included in the message.

The message may comprise certificate data 502, which in some embodiments may comprise a certificate presented on the blockchain for signing. The certificate data 502 may comprise a version number 504, a serial number 506, a signature algorithm 508, a name or identifier of an entity presenting the certificate 510, a public key 512 associated with the certificate or in other embodiments, with the name or identifier of the entity presenting the certificate 510.

In other embodiments the certificate data 502 may comprise one or more of: an X.509 certificate, a CVC certificate, an OpenPGP certificate, an other standard digital certificate.

In some embodiments the message may comprise an identity 514 of an entity to whom a request to sign the certificate is presented. In other embodiments the identity 514 may comprise a list of a plurality of identifiers corresponding to a plurality of entities.

In some embodiments the message may comprise a time stamp 516. In some embodiments, the time stamp 516 may indicate a time at which the message was created. In other embodiments the time stamp 516 may indicate a time before which the request to sign may be responded to, after which the request may become invalid.

In some embodiments the message may comprise a hash 520 of some or all of a preceding message data. The hash 520 may be calculated from a part or all of the preceding message data using a cryptographic hash algorithm, for example: SHA, RIPEMD, Whirlpool, Scrypt, HAS-160, BLAKE, or other cryptographic hash function.

In some embodiments the message may comprise a digital signature 522. The hash 520 may be signed using a private key corresponding to the public key 512 in order to generate the digital signature 522. In other embodiments the hash 520 may be signed with a private key corresponding to a public key associated with the name or identifier of the entity presenting the certificate 510.

In some embodiments the message may comprise a signed digital credit transaction 524, which may comprise a script or smart contract for transferring tokens or digital credits of commercial value. The signed digital credit transaction may be signed with the private key corresponding to the public key 512, or in other embodiments, with a private key corresponding to a public key associated with tokens or digital credits of commercial value.

In some embodiments the signed digital credit transaction 524 may comprise a script or smart contract that automatically transfers tokens or digital credits of commercial value to a signer of the certificate included in the certificate data 502.

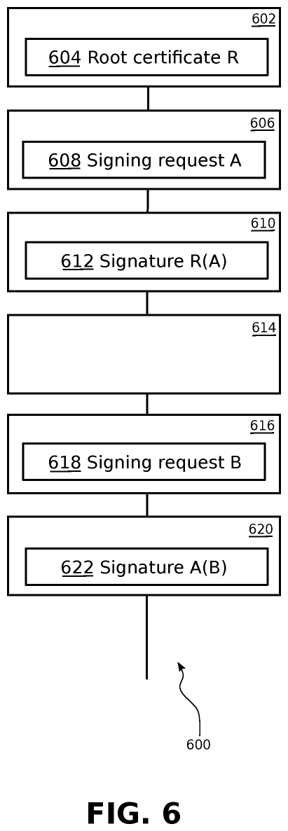

In FIG. 6 an illustration of a chain of digital certificates and authorization signatures on a blockchain 600 is presented.

In an embodiment, a block 602 may comprise a certificate announcement message 604, said certificate announcement message comprising a root certificate R.

A subsequent block 606 may comprise a signing request 608 for a certificate A.

A further block 610 may comprise a signature message 612, said signature message 612 comprising a signature R(A), wherein certificate A may be signed by root certificate R.

An other block 614 may not comprise a certificate message, signing request, or signature message.

An other further block 616 may comprise a further signing request 618 for a certificate B.

An other subsequent block 620 may comprise a further signature message 622, said further signature message 622 comprising a signature A(B), wherein certificate B may be signed by certificate A.

Those skilled in the art will appreciate from the above disclosure that the blockchain 600 comprises a sequence of certificates, signing requests and signatures, whereby a chain of authorization extends from root certificate R to a certificate B. In general, the method may be extended to include a longer chain, a tree, a web, or a tangle of interdependent signed certificates.

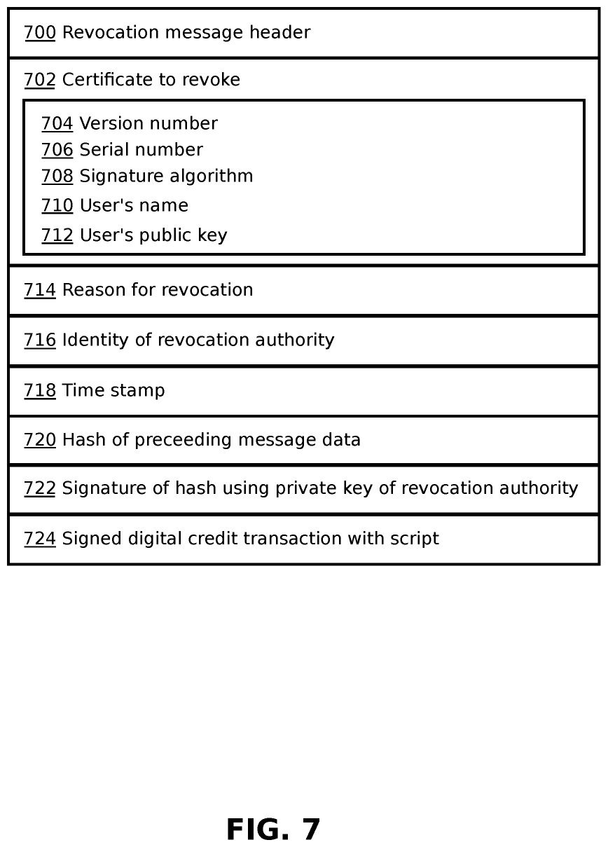

In FIG. 7 an exemplary embodiment of a revocation message comprising a revocation command for a digital certificate and an offering of credits of commercial value, that may be published on a blockchain, is presented.

The message may comprise a header 700, which in some embodiments may comprise: an identifier indicating that the message comprises a revocation command, a size of the revocation message, a protocol for the revocation message, a structure of data included in the revocation message.

The revocation message may comprise certificate data 702, which in some embodiments may include details of a certificate previously presented on the blockchain that is to be revoked. The certificate data 702 may comprise a version number 704, a serial number 706, a signature algorithm 708, a name or identifier of an entity owning the certificate 710, a public key 712 associated with the certificate or in other embodiments, with the name or identifier of the entity owning the certificate 710.

In other embodiments the certificate data 702 may comprise one or more of: an X.509 certificate, a CVC certificate, an OpenPGP certificate, an other standard digital certificate.

In some embodiments the revocation message may comprise a reason for revocation 714. The reason for revoking the certificate may comprise one or more of, but not be limited to: the certificate has expired and is no longer valid; the certificate private key has been lost, stolen or compromised; a domain name within the certificate has been changed; a website listed in the certificate is no longer in service; a certificate owner failed to adhere to certificate policy requirements or blockchain protocol requirements; the root certificate or an intermediate authorizing certificate has been compromised.

In some embodiments the revocation message may comprise an identity 716 of an entity issuing the revocation command, namely a revocation authority. In other embodiments the identity 716 may comprise: a list of a plurality of identifiers corresponding to a plurality of entities issuing the revocation command, a certificate identifier, a list of a plurality of certificate identifiers.

In some embodiments the revocation message may comprise a time stamp 718. In some embodiments, the time stamp 718 may indicate a time at which the revocation message was created. In other embodiments the time stamp 718 may indicate a time from which the revocation message is considered valid.

In some embodiments the revocation message may comprise a hash 720 of some or all of a preceding message data. The hash 720 may be calculated from a part or all of the preceding revocation message data using a cryptographic hash algorithm, for example: SHA, RIPEMD, Whirlpool, Scrypt, HAS-160, BLAKE, or other cryptographic hash function.

In some embodiments the revocation message may comprise a digital signature 722. The digital signature 722 may be generated by signing the hash 720 using a private key corresponding to a public key associated with the revocation authority.

In some embodiments the revocation message may comprise a signed digital credit transaction 724, which may comprise a script or smart contract for transferring tokens or digital credits of commercial value. The signed digital credit transaction may be signed with the private key corresponding to the public key associated with the revocation authority, or in other embodiments, with a private key corresponding to a public key associated with tokens or digital credits of commercial value.

In some embodiments the signed digital credit transaction 724 may comprise a script or smart contract that automatically transfers tokens or digital credits of commercial value to participants on the blockchain acting on the revocation message, for example by providing further signatures to the revocation message, or by deleting the digital certificate 702.

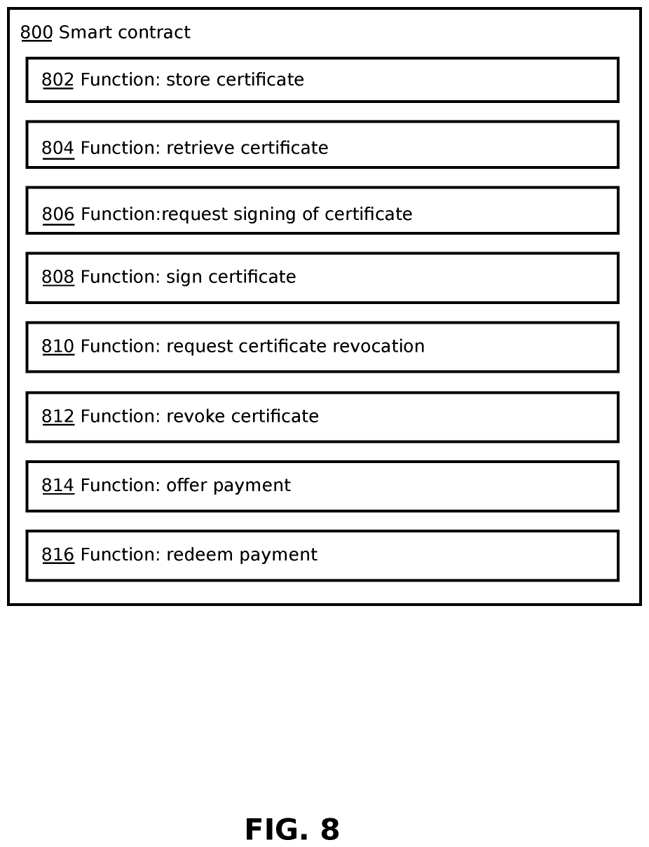

In FIG. 8 an exemplary embodiment of a structure of a smart contract 800 is presented. In the exemplary embodiment the smart contract 800 may provide blockchain functionality to manage certificates and associated token payments.

In some embodiments the smart contract 800 may comprise a function 802 for storing a certificate on the blockchain. In further embodiments the smart contract 800 may store the certificate on the blockchain in encrypted form.

In some embodiments the smart contract 800 may comprise a function 804 for retrieving a certificate from the blockchain. In further embodiments the smart contract 800 may retrieve and decrypt an encrypted certificate retrieved from the blockchain.

In some embodiments the smart contract 800 may comprise a function 806 generating a request for signing a certificate on the blockchain.

In some embodiments the smart contract 800 may comprise a function 808 generating a signature for a certificate. In further embodiments, a combination of a call to function 804 and function 808 may result in a fulfillment of a request made to a call to function 806.

In some embodiments the smart contract 800 may comprise a function 810 generating a revocation request for a certificate and publishing it on the blockchain.

In some embodiments the smart contract 800 may comprise a function 812 revoking a certificate when called with appropriate parameters. The appropriate parameters may compromise: a reference to a revocation request, a certificate identifier, a digital signature authorizing a revocation.

In some embodiments the smart contract 800 may comprise a function 814 offering payment. Payment may be associated with a request to sign a certificate, or a request to revoke a certificate. In other embodiments payment may be associated with a request to retrieve or to store a certificate. Payment may comprise a transfer of tokens or digital credits of commercial value from one entity to another.

In some embodiments the smart contract 800 may comprise a function 816 to redeem payment. In further embodiments the function 816 may be called with a reference to an offer of payment, and may be executed on responding to a request for signing a certificate, a request to revoke a certificate, a request to retrieve a certificate, or a request to store a certificate.

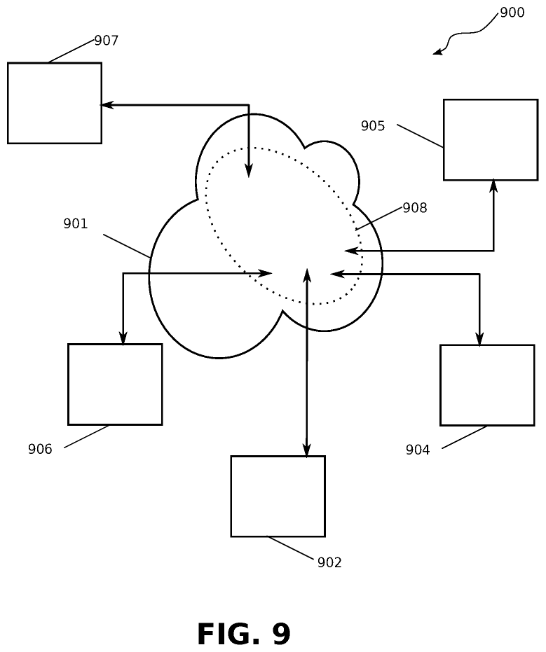

The systems and methods disclosed above may be embodied in a system of a plurality of network connected devices communicating through the medium of a peer-to-peer network system 900, as shown schematically in FIG. 9.

As depicted, the peer-to-peer network 908 may be embodied within a packet switched network 901, through the interconnection of the plurality of network connected devices on the peer-to-peer network 908.

A device 902 may connect to the peer-to-peer network. The device 902 may initiate a blockchain.

Other devices connected the peer-to-peer network may include a network connected device acting as a node 904, whose role is to maintain a list of other devices connected through the peer-to-peer network, and to forward on received network messages to those devices on the list, possibly independently, or possibly as a response to a request from another network connected device. As one skilled in the art will be aware, no individual node is required to have a complete list of all devices, as the process of peer-to-peer networking only requires that a union of a set of all nodes contains a complete list of all devices on the peer-to-peer network, and for every pair of network connected devices there is a network route from one device to the other, possibly via a set of one or more nodes. Therefore, the only requirement to be a participant on the peer-to-peer network is to establish a connection to one or more of the nodes on said network.

Further devices connected via the peer-to-peer network may include one or more network connected devices 905, 906 acting as a miner, whose role is to receive or request certificate signing and certificate revocation messages from the peer-to-peer network, process them according to a protocol of the blockchain, and transmit the results of said processing back to the peer-to-peer network for inclusion in the blockchain.

A further device 907 may connect to the peer-to-peer network as a client, and may submit a certificate signing request, a certificate revocation request, or other messages as disclosed above.

The technology described herein is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Pentium® Pro processor, a 8051 processor, a MIPS® processor, a Power PC® processor, or an Alpha® processor. In addition, the processor may be any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic-link library.

The system may be used in connection with various operating systems such as Linux®, UNIX® or Microsoft Windows®.

The system may be written in any conventional programming language such as C, C++, Pascal, or Java, and run under a conventional operating system. C, C++, Pascal, Java, and FORTRAN are industry standard programming languages for which many commercial compilers can be used to create executable code. The system may also be written using interpreted languages such as Perl, Python or Ruby, or languages that may either be compiled or interpreted, such as BASIC or Lisp.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, micro-controller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

As will be appreciated from the above discussion, an advantage of the systems and methods of this disclosure include issuance, verification and revocation of digital certificates, and associated digital credit transfers, in a decentralized fashion without recourse to a central authority, namely through the medium of a blockchain.

What is claimed is:

1. A method for distributing digital certificates, comprising:
initiating a blockchain;
publishing a root certificate on the blockchain;
retrieving a message comprising a signing request for a digital certificate;
generating a signature in response to the message using a key associated with the root certificate; and
publishing the signature on the blockchain.

2. The method of claim 1, wherein the root certificate is published in an initial block of the blockchain.

3. The method of claim 1, further comprising rejecting a validity of the digital certificate if the blockchain does not comprise the signature.

4. The method of claim 1, further comprising rejecting the validity of the digital certificate if a revocation message for the digital certificate is published on the blockchain.

5. The method of claim 4, wherein the revocation message is signed by an authorizing digital certificate.

6. The method of claim 1, wherein the signature comprises an authorization for the digital certificate to sign further certificates.

7. The method of claim 1, wherein the message is associated with an offering of digital credits of commercial value, and publishing the signature is associated with claiming the digital credits of commercial value.

8. The method of claim 1, wherein one or more of: the signature, the root certificate, the message, the digital certificate, the revocation message, and the digital credits of commercial value, are stored in a smart contract.

9. An apparatus, comprising:
a processor and a transceiver, configured to:
initiate a blockchain;
publish a root certificate on the blockchain;
retrieve a message comprising a signing request for a digital certificate;
generate a signature in response to the message using a key associated with the root certificate; and
publish the signature on the blockchain.

10. The apparatus of claim 9, wherein the transceiver is further configured to publish the root certificate in an initial block of the blockchain.

11. The apparatus of claim 9, wherein the processor is further configured to reject a validity of the digital certificate if the blockchain does not comprise the signature.

12. The apparatus of claim 9, wherein the processor is further configured to reject the validity of the digital certificate if a revocation message for the digital certificate is published on the blockchain.

13. The apparatus of claim 12, wherein the revocation message is signed by an authorizing digital certificate.

14. The apparatus of claim 9, wherein the signature comprises an authorization for the digital certificate to sign further certificates.

15. The apparatus of claim 9, wherein the message is associated with an offering of digital credits of commercial value, and the processor and transceiver are configured to claim the digital credits of commercial value on publishing the signature.

16. The apparatus of claim 9, wherein one or more of: the signature, the root certificate, the message, the digital certificate, the revocation message, and the digital credits of commercial value are stored in a smart contract.

17. A non-transitory computer readable medium configured to store instructions that when executed cause a processor to perform:
initiating a blockchain;
publishing a root certificate on the blockchain;
retrieving a message comprising a signing request for a digital certificate;
generating a signature in response to the message using a key associated with the root certificate; and
publishing the signature on the blockchain.

18. The non-transitory computer readable medium of claim 17, wherein the processor is further configured to publish the root certificate in an initial block of the blockchain.

19. The non-transitory computer readable medium of claim 17, wherein the processor is further configured to reject a validity of the digital certificate if the blockchain does not comprise the signature.

20. The non-transitory computer readable medium of claim 17, wherein the processor is further configured to reject the validity of the digital certificate if a revocation message for the digital certificate, determined as valid by the processor, is published on the blockchain.

21. The non-transitory computer readable medium of claim 20, wherein the processor is further configured to determine the revocation message as valid if the revocation message is signed by an authorizing digital certificate.

22. The non-transitory computer readable medium of claim 17, wherein the signature comprises an authorization for the digital certificate to sign further certificates.

23. The non-transitory computer readable medium of claim 17, wherein the message is associated with an offering of digital credits of commercial value, and the processor is further configured to claim the digital credits of commercial value on publishing the signature.

24. The non-transitory computer readable medium of claim 17, wherein one or more of: the signature, the root certificate, the message, the digital certificate, and the revocation message, are stored in a smart contract.
